(19) United States
(12) Patent Application Publication
(10) Pub. No.: US 2009/0224889 A1
(43) Pub. Date: Sep. 10, 2009

(54) SYSTEM AND METHOD FOR UNIVERSAL IDENTITY VERIFICATION OF BIOLOGICAL HUMANS

(76) Inventors: Abhinav Aggarwal, Chapel Hill, NC (US); Parv Aggarwal, Chapel Hill, NC (US); Sarita Aggarwal, Chapel Hill, NC (US)

Correspondence Address: DR. ABHINAV AGGARWAL, 100 SAINT AYERS WAY, CHAPEL HILL, NC, 27517, US

(21) Appl. No.: 12/395,669

(22) Filed: Mar. 1, 2009

Related U.S. Application Data
(63) Continuation-in-part of application No. 10/735,333, filed on Dec. 12, 2003.

(51) Int. Cl. H04Q 5/22

(52) U.S. Cl. 340/10.4

(57) ABSTRACT

A system and method to generate a Universal Identification Number (UIN) for every human being on the planet, and its RFID application to uniquely verify the identity, and apparatus for biosensor integrated device receiving GPS or cellular signals to determine location, and transmitting data through radio signals to identify, track, monitor, and rescue humans. UIN database comprising of public, health, and confidential data, protects privacy by hiding the sensitive information and providing the required information only to authorized agencies on ‘need to know’ basis, like medical emergency data to authorized hospitals for advance preparedness to save lives or to law enforcement agencies when authorized under specific circumstances. UIN secures credit, debit and ATM card transactions through additional code verification and fulfills a pending need for technological system to eliminate child abduction, identity fraud, credit card theft, terrorism, and helps in saving lives of people.

### CROSS-REFERENCE TO RELATED APPLICATIONS

This application is continuation-in-part of previously filed application Ser. No. 10/735,333 (filing date Dec. 12, 2003 with USPTO).

### BACKGROUND OF THE INVENTION

1. Field of the Invention

Human identification, tracking, monitoring, and alert detection through biosensor triggered or self initiated distress signal indicating human location calculated by receiving GPS or cellular signals, and transmitted through secondary radio channels, enabling rescue.

Present invention relates to a system and method for uniquely identifying biological humans, building a database of public, health, and confidential records that can be accessed as needed and information made available to authorized agencies on a “need to know” basis, an apparatus to track, monitor, and rescue in case of an emergency, and enabling access to emergency life saving data to authorized hospitals and paramedics.

2. Background Art

Currently available systems don't specifically address the issues of a globally available identification mechanism that covers each and every individual on the planet. While each country may have its own identification system, there is no global identification system that uniquely identifies each and every human being on the planet across the boundaries of nations, and enables determination of location and rescue in case of an emergency.

Tam (U.S. Pat. No. 6,968,457) describes the method to verify personal identity biometric data and access it in a secure manner by pre-defined finger print sequence, but does not define a system to issue a unique number that can cover every single human being on the planet, or an apparatus to track, monitor the location, and rescue in case of an emergency.

Elggren (U.S. Pat. No. 4,557,693) describes a device and method for applying and retaining a unique data carrier to a tooth surface of an individual, adapted for detection by a reader which can be operated by a third person. While this system is useful in establishing the identity of an individual when a body is found and if the data wafer can be located on the found body, there is no provision to generate an alert and rescue the human being in case of a medical or other emergency.

The Amber Alert system is only a paging mechanism to alert public of child abduction, so that they can be on the look out for the abductors and report suspected activity to police. There is no technology enabled system in place to detect the abduction, or to enable the child to raise a distress signal and get rescued.

Unique Identification of biological humans is of vital importance. The data related to the biological human that uniquely identifies, is of a critical nature and must be made available upon requirement in the emergency situations to save human life. For example, a particular patient's blood type shall reveal an important data that can be crucial to saving time for an immediate medical treatment. Also, prior knowledge about allergies can prevent a wrong drug from being administered. In addition, complete confidential data that can be of vital importance for law enforcement agencies must be available at all times for verification and prevention of identity frauds and will enforcement.

At present, there is no system and method that uniquely identifies a human being on a global basis. Several national initiatives in this regard hold data about individuals in an isolated and disjointed manner. There may or may not be a cross-reference between several identities that a human being may hold. For instance, a Social Security Card may not reference to a driving license number. Also, data pertaining to several numbering schemes can be tapped and used by the fraudulent persons for financial frauds or criminal purposes. If someone is collecting data about a particular person from the discarded mail, it can be possible for them to figure out a lot of personal information that is of a confidential nature. Subsequently, this information can be used with the intent of fraud. The UIN system is specifically designed to address these issues and prevent attempts at fraud.

A major problem with all the existing identification systems is that they are not global in nature, but specific only to the organization which develops and implements that particular arrangement or scheme. A particular country may use one identification scheme and an adjoining country may use a completely incompatible scheme. As a result, even though the scheme may properly identify the human within the territory of a specific nation, it may provide no usable identification when the human crosses the boundaries and visits another country. With the globalization taking place at a faster pace and the likely merging of nations, like European Union, UIN addresses the need for a technology based global human identification and tracking system.

Another significant problem with the prior art schemes is that they do not ensure confidentiality and privacy of data about the individual concerned. For example, if a person's social security number (SSN) is used as the identifier for medical insurance coverage and the medical insurance policy number becomes the SSN suffixed by a zero or some other digit, all correspondence from the medical insurance company for that person will use the same identifier. As a result, the confidential data about the person is prone to be exposed and misused.

The prior art identifying arrangements and schemes may also permit tampering. For example, a person may provide the forged documents or a wrong social security number or name, while visiting another country for record keeping. In the absence of an arrangement for sharing such data across nations, the potential of allowance for error can result in duplicity with the claimed identity belonging to another person having that true number or name or document.

Lack of an international system for uniquely identifying every human being has allowed margins for forged identities and illegal border crossings with malicious intent, enabling terrorists to carry out operations like the events of Sep. 11, 2001, and the Mumbai attacks in November, 2008. Currently, states are unable to implement the ‘Real Id Act’ based on the recommendations of the 9/11 commission report, as there is no existing system that enables them to access and verify human identification documents issued by other countries and states. UIN overcomes all such limitations.

There is no existing arrangement with any prior art identification scheme to uniquely identify every human being on a global basis. Thus, UIN is a unique system and method that overcomes these shortcomings of prior art schemes and it makes the identification documents secure by embedding RFID (Radio Frequency Identification) tags. UIN is the first system to uniquely combine bio-sensing and LEO and GPS Satellites, RFID, and cellular technology in an integrated solution for human identification, tracking, and rescue, and carries practical usage in security applications. UIN fulfills a long pending need for a technology based solution to prevent child abduction, save lives, eliminate identity frauds and eradicate terrorism from the soil of our planet.

### SUMMARY OF THE INVENTION

This invention discloses a system and method for generating and applying global unique identification number as universal identification number (UIN) that forever uniquely identifies each and every human being on the planet from birth to death and after, and is used as a cross reference identifier for enabling identity verification, issue of passport, visa for travel to a foreign country, driving license, credit card, debit card, automated teller machine card issue and verification, human and patient tracking, monitoring, medical record access for speedy diagnosis and treatment, and human rescue in conjunction with radio frequency identification (RFID), microwave, cellular communication, wi-fi, and satellite communication technologies and network access. The queries for identity verification and data access are received securely over a messaging framework and authorized database access is provided after duly validating the identity of the seeker.

UIN is used as the reference to collect information of public interest, vital life saving data, and that of a confidential nature and store these records into a database. When required, these records can be retrieved for providing the information on a ‘need to know basis,’ to authorized seekers. For each level of access, a different authorization code is required. The authorized medical or law enforcement agency must have access to this code, to get the relevant. information about the UIN holder.

The UIN card issued to the UIN holder, shall be embedded with a radio frequency identification (RFID) tag for security and contain limited information about the contact details of the individual human being and the emergency medical data. The UIN card would not contain any information that is of a confidential nature. This is to protect privacy of the individual, in case the card is lost and falls into the wrong hands.

UIN Human Identification and Tracking System (HITS) is an apparatus that comprises of a wearable device capable of calculating its location by receiving global positioning satellite (GPS) signals, and transmitting an alert with UIN information and a triggered by either biosensor driven detection of an abnormal body condition, or by manually pressing a distress signal button. This signal is transmitted through alternate radio transmission channels like low earth orbit (LEO) satellites, cellular networks, and wi-fi, and received at the UIN monitoring site that immediately dispatches the rescue squad or ambulance, and provides vital life saving medical data to paramedics and authorized hospitals to aid speedy diagnosis and treatment.

UIN system is also used for credit, debit, and automated teller machine card transaction verification by matching an additional access code known to the holder of universal identification number, and can alert the card issuer and law enforcement agencies after the pre-specified number of attempts at input of correct authorization code fail, as agreed between the card holder and issuer.

### BRIEF DESCRIPTION OF THE DRAWINGS

FIG. 1 gives details of the flowchart for issue of UIN (Universal Identification Number).

FIG. 2 shows the steps involved in State Id or Driver's License Renewal system using UIN.

FIG. 3 shows the steps involved in linking the State Id or Driver's Licenses issued by State to UIN.

FIG. 4 shows the steps involved in Law Enforcement Check Point application using UIN.

FIG. 5 shows the steps involved in Credit Card Transaction Verification Application using UIN.

FIG. 6 shows the Type 1 UIN Card issue process.

FIG. 7 shows the Type 2 Integrated UIN Card issue process.

FIG. 8 shows the processes involved in UIN global birth data collection system

FIG. 9 shows the interactions between various components of a UIN based Human Identification and Tracking System (HITS).

### DETAILED DESCRIPTION OF THE EMBODIMENT

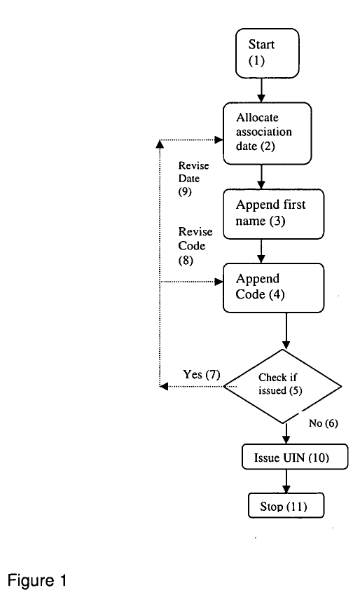

Referring to FIGS. 1 through 9 in the drawings, this invention comprises the steps of issue of a globally unique identification as universal identification number (UIN) to each individual human being on the planet, such that this number is issued only once, and linking all existing identifications to it, and using this system to access data for the applications like law enforcement check point and credit/debit card transaction verification, issue of passport/visa, loyalty programs, and human/patient monitoring, tracking, and rescue using satellite, cellular, RFID, wi-fi, biosensing, and secured network and database access technologies and a messaging framework.

Specifically referring to FIG. 1, the flowchart depicts the steps involved in the issuing of a UIN:
(1) The start of UIN generation and allocation process to a new applicant.
(2) Allocation of the association date.
(3) Appending the First Name characters.
(4) Appending the computer generated alpha-numeric code.
(5) Checking if the UIN generated at step (4) is already issued by searching the UIN database.
(6) Clearance for issue of UIN if the check at step (5) reveals that the UIN generated at step 4 is not already issued, and is thus available for issue to the current applicant, move to step (10).
(7) If the UIN is not available for issue, then revise the UIN in the order of:
(8) Revising the computer generated alpha-numeric code, and if required
(9) Revising the association date.
(10) Looping through the process of checking, when it is established that the revised UIN is available for issue, it is issued to the current applicant, and details are added to the UIN database.
(11) Stop indicates the confirmation that UIN has been issued, and the process of UIN issue started at 1 above has been terminated.

In addition, the step at (2) above comprises of calculation the appropriate association date as per following algorithm schema details, and subsequent checking through above steps (3) to (10) for UIN Issue.

Example Case: Issue of UIN for a person named Joe on 2002 Nov. 6.
1. Pick current date yyyymmdd as A (Association date).
2. Suffix yyyymmdd (A) with nnn (JOE) such that yyyymmddnnn is now B
3. Suffix B with cccc (Computer-generated Code).
4. The whole field is yyyymmddnnncccc. This is UIN_Temp (the temporary UIN).
5. If cccc is PN2R, UIN Temp is 20021106JOEPN2R.
6. Check if UIN_Temp is already in UIN_Issue list
7. If no, Issue UIN_Temp as UIN_Issue to Joe and add UIN_Temp (20021106JOEPN2R in this case) to UIN_Issue list
8. If yes, check for availability of another cccc combination for B and make it UIN_Temp.
9. Go to 6. Keep repeating the loop of steps 6 through 8 till all possible combinations of cccc are exhausted.
10. If there is no cccc match available for Joe for current date yyyymmdd (20021106 in this case), decrement current date by 1, such that new Association date (A) is now previous (last used) association date-1 (200021105 in this case).
11. Go to step 2. Keep repeating the loop of steps 2 through 10, till a valid UIN is found to break away from the loop at step 8 and becomes UIN_Issue for Joe.

In addition, the basis for step at 4 above comprises of calculating the appropriate length for the computer generated alpha-numeric code as per following detail:
Existing population of the world that needs to be issued UIN=approx. 7 billion
Existing human birth rate of the world=6.5 births per second Human births in the world (highest rate data, with margins)=10 per second
Human births in the world (highest rate data, with margins)=10×60 per minute
Human births in the world (highest rate data, with margins)=10×60×60 per hour
Human births in the world (highest rate data, with margins)=10×60×60×24 per day
=864000 births per day
Assuming that every person on the planet was given the same first name (say AAA),
And considering that we use A to Z and 2 to 9 (excluding 0 and 1 to avoid confusion with 0 and 1) that totals to 26+7=34 alphanumeric characters such that each C (Computer generated Alphanumeric Code) holds the 34 possible options.
CC=34×34=1156
CCC=34×34×34=11256×34=39304
CCCC=34×34×34×34=39304×34=1336336

Since 1336336 exceeds 864000, an alphanumeric length of 4 characters (cccc) is sufficient to cover all human births in the world, even if everyone was given the same first name, on any particular day. If this particular day is the UIN issue date, that date would be used as the association date. To cover the existing 7 billion population of the world, if a particular first name can't be associated with any computer-generated code within the cccc length limit, the immediately preceding date shall be used as the association date. When implemented on a universal scale through UIN global birth data collection system, the association date is not the birth-date of the UIN holder, but the date that is assigned as the association date by the UIN generation system.

A UIN shall be issued to all those who apply for it, through a single controlling agency or a combination of several agencies, who work in coordination with each other so that they all follow the same system and method for issue of UIN, to avoid any redundancy and confusion. Such coordinated efforts of interacting agencies shall organize to reach and cover every human being on the planet in a phased manner.

An access code that is based on the registered name of the applicant and a computer generated alphanumeric code with year, month and date of issue is given to the applicant. This access code is internally mapped to authenticated data that has been received from the applicant. While the access code acts as the UIN for the applicant, internal mapping of the UIN relates to three separate domains of data. Since the access code is based on just the name and an alphanumeric code, complete privacy is maintained, yet providing the power and flexibility to identify the applicant when needed and provide all relevant information in times of a medical emergency.

The three domains for level of data access are:

1. Public

2. Health

3. Confidential

Public domain relates to a personal website of the applicant where they can opt to put any professional and personal information that can help them to reach out to the world. A categorization of inspired or acquired interests and capabilities would be offered for selection that can be viewed and searched by the world to reach and contact the UIN holder for any professional or personal reasons. The applicant has a choice to opt out of this facility. A unique web-site URL and e-mail address can be provided to all those who opt for this service. The data to be collected under this domain is: Name, contact information: telephone, e-mail address, Postal address.

Health domain data holds all vital information that can be released to the hospitals or any authorized medical personnel in case of medical emergencies. This would rid the burden on UIN holder to carry all medical records with them and also speed up the process of diagnose and save lives by providing faster treatment. This data is not accessible to the public.

The data to be collected under this domain is: Blood Type, All known allergies with antidotes, last treatment and contact details of the treating physician; any special information that is of relevance and medical conditions (can include pointers to other medical record databases), current medications, immunization, any significant past history, details of medical insurance, if any.

Confidential domain holds the personal data related to the UIN holder that is not available to anyone for access under normal circumstances. Only under certain circumstances, the authorized law enforcement agencies or the appropriate court order from a specified set of countries or an international court, can request such data. This is the data that establishes undoubted identity of the UIN holder. This data has highest level of access security. The data to be collected under this domains is: Name, Surname, Middle name (if any), Maiden name (if any). Date of birth, time of birth, place of birth with complete address. All addresses where resided for over five years. All addresses, where resided within past ten years for periods exceeding six months with reason for move. Details of all identities issued so far: Passports, driving licenses, Social Security Cards, Election ID Cards, Ration Cards, or any others issued or applied for: with details of place, date and authority of issue. Whether any security clearances applied for and were those issued/ rejected. Nationality (current and past, with dates from which switched). Any active or past visas with status. Fingerprints, Eye Iris pattern, DNA samples. Pictures (Face: front, side-left, side-right). Pictures (Standing: front, standing-left, standing right). Height, weight, dimensions: chest, waist, hips). Color of hair, eyes and skin. Identification marks, birth marks. Educational and professional qualifications, associations and affiliations with any Religious, Professional and Voluntary bodies or organizations with dates and status held. Additionally, a DNA sample is obtained, linked to the UIN, and kept at a secured site.

All data can be updated periodically and made accessible at all times to authorized agencies. No one would be entitled to upload or modify the data on-line. The modification shall be done only by the appointed authorities of the controlling agency, upon appropriate verification for authenticity of modifications. This shall prevent any efforts at unauthorized modification.

Additionally, data on personal, professional, cultural, social achievements and family tree relations can be obtained and maintained under public domain, if agreed by the UIN holder, and used for genealogy applications.

Levels of Security for Data Access:

The access code is the preliminary level security access that is known to the UIN holder, but is not displayed on the UIN card (UIN is encoded and can be read by swiping the card by authorized agencies). This is to ensure that no one can access their (UIN holder's) data without their knowledge. The authorization code is the security access that is known only to the authorized agencies and can be periodically changed to enable access only to the genuine authorization code holders.

For instance, when an agency is provided with the UIN Number and access code, if that agency is not authorized to get access to the data, they would not be able to get the data (this would happen if they don't have the authorization code) This shall prevent any fraudulent access to the data, thus protecting the identity and privacy of UIN holder. It shall also prevent the UIN holder from playing into the hands of any bogus agency who may be just fooling people around to a trap where they can divulge the sensitive information. All UIN holders would be encouraged to check back on authenticity of the agency seeking information with UIN Controlling Office, to protect their identity.

The confidential data shall not be available on-line, to prevent any potential attempts at hacking. This data shall be maintained only on centralized databases that would be maintained and accessed by authorized personnel at certain designated locations.

Thus, we can summarize as follows:

Primary Access: UIN

Additional Access Code: UIN Holder

Authorization Code with different access levels: Medical agencies, Law Enforcement Agencies.

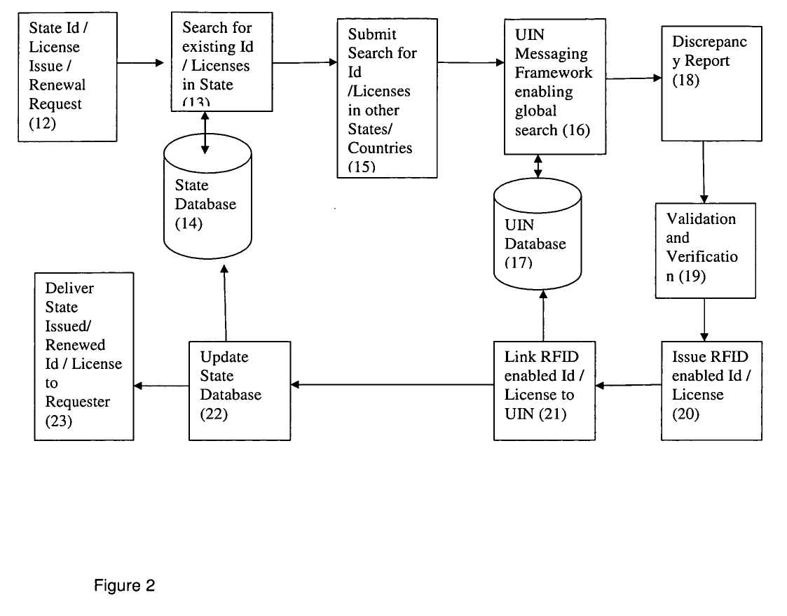

Specifically referring to FIG. 2, the process of issue and renewal of state issued Ids and driver's licenses linked to UIN comprise the steps of:
(12) State Id or Driver's License Issue or Renewal request is received from an applicant.
(13) A request for search for existing Ids and Licenses in the State is submitted.
(14) State Database is searched.
(15) A Submit Search for Id or Driver's Licenses in other States and Countries is submitted.
(16) UIN Messaging Framework picks up the request from step (15) and enables a global search.
(17) UIN global database is searched.
(18) A discrepancy report is generated that provides the details of any possible duplicate identities issued to the applicant by any state or country based on the global search using UIN as the cross-reference identifier.
(19) Validation and verification is carried out by the state Id issue agency based on the discrepancy report generated at step (18) above, and a decision made towards issue of the Id or license to applicant.
(20) If a positive decision is made, a RFID enabled Id or driver's license, as the case may be, is issued.
(21) The RFID enabled driver's license, issued at step (20) above is linked to the UIN (a new UIN is generated for new issue request, and if the UIN already exists, the Id or license renewal details with RFID tag data are input), and the UIN database is updated.
(22) The state database is updated with newly issued or renewed Id or license details.
(23) The newly issued or renewed Id or license is delivered to the applicant.

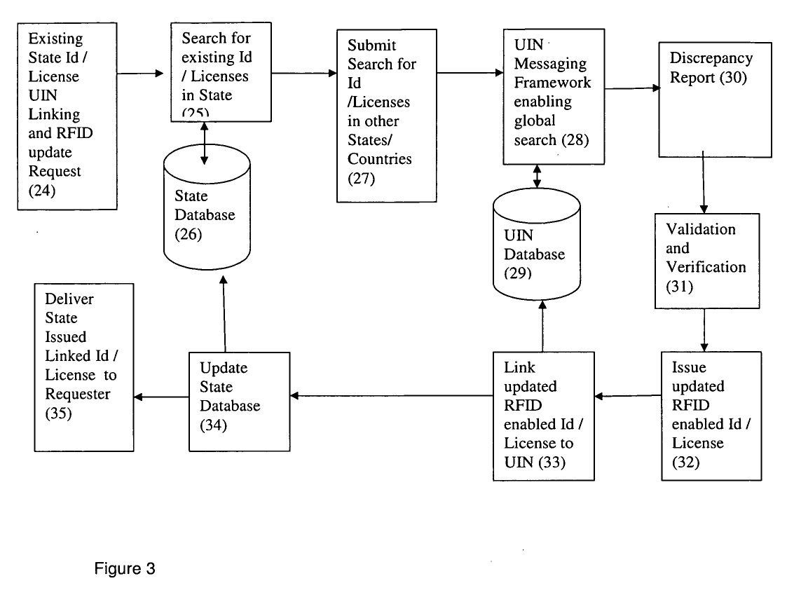

Specifically referring to FIG. 3, the process linking already state issued Ids and driver's licenses to UIN and updating with RFID enablement comprise the steps of:
(24) State Id or Driver's License updating with RFID enablement and UIN linking request is received from an applicant.
(25) A request for search of existing Ids and Licenses in the State is submitted.
(26) State Database is searched.
(27) A Submit Search for Id or Driver's Licenses in other States and Countries is submitted.
(28) UIN Messaging Framework picks up the request from step (27) and enables a global search.
(29) UIN global database is searched.
(30) A discrepancy report is generated that provides the details of any possible duplicate identities issued to the applicant by any state or country based on the global search using UIN as the cross-reference identifier.
(31) Validation and verification is carried out by the state Id issue agency based on the discrepancy report generated at step (30) above, and a decision made towards issue of the RFID updated and UIN linked Id or license to applicant.
(32) If a positive decision is made, a RFID enabled Id or driver's license, as the case may be, is issued.
(33) The RFID enabled driver's license or Id, issued at step (32) above is linked to the UIN (a new UIN is generated for new issue request, and if the UIN already exists, the Id or license renewal details with RFID tag data are input), and the UIN database is updated.
(34) The state database is updated with newly RFID updated and UIN linked Id or license details.
(35) The RFID updated and UIN linked Id or license is delivered to the applicant.

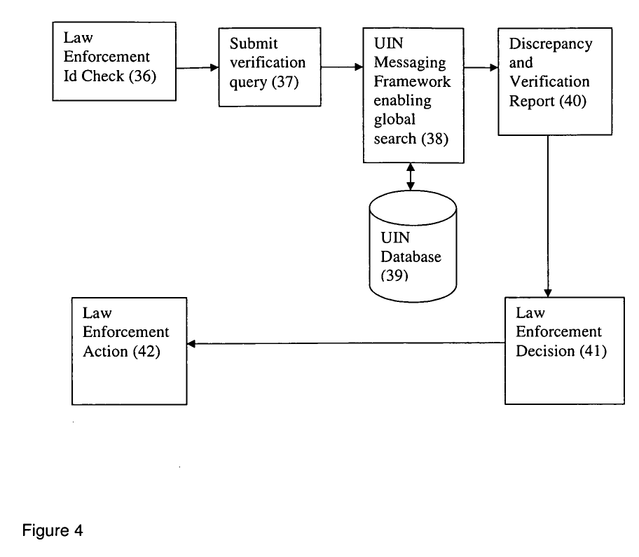

Specifically referring to FIG. 4, Law Enforcement Check Point Application using UIN linked and RFID enabled Ids comprises the steps of:
(36) State law enforcement agent performs an Id or Driver's License check.
(37) Using a hand-held RFID scanner, the Id or License RFID passive tag is energized and data read on the RFID reader, and optionally on the basis of any suspicion, the state law enforcement agent can submit a verification query. This verification query uses the RFID tag read data and submits it through a radio or line link through the available network.
(38) The UIN Messaging Framework picks up the query request from step (37).
(39) The RFID enabled and UIN linked Id or license is searched for in the UIN database and the authenticity of the Id or license is verified.
(40) A discrepancy report is generated that provides the details of any possible infringements committed by the potential suspect based on the global search using UIN as the cross-reference identifier.
(41) Based on the discrepancy report, the law enforcement agency makes a decision.
(42) Based on the decision made at step (41), the law enforcement agency may carry out an action.

If the UIN monitoring site receives requests for providing information about the universal identification number holder, first of all it authenticates the identity of the seeking agency, and in addition, specifically of the caller from that agency. The caller must identify themselves by providing their own UIN, followed by additional authentication of the access code of the seeking agency. It is only after appropriately processing and validating these authentications, and establishing the appropriateness and legal authority of request to seek information that the request can be fulfilled, and all such requests are logged with date and time stamp and details of the identity of the seeking agency, the person seeking and providing the information with their UIN records, and the legal authorization under which the information was sought, and what information was provided.

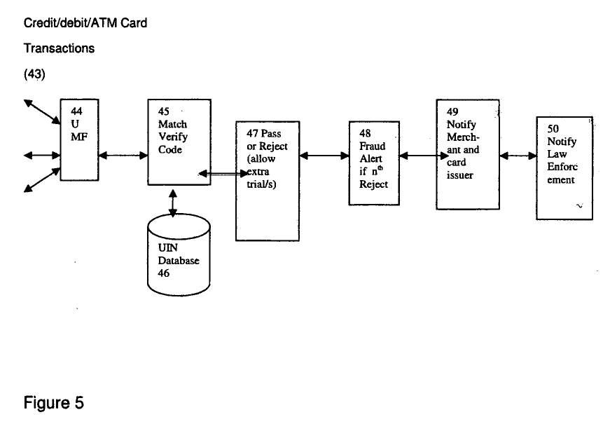

Specifically referring to FIG. 5, Credit/Debit Card Transaction Verification Application comprises the steps of:
(43) Credit/debit card transaction is received for verification.
(44) The transaction for verification is picked by the UIN Messaging Framework.
(45) The verification is carried out by matching the secure access code input by the UIN holder while performing the transaction.
(46) The secure access code is matched in the UIN database.
(47) Upon success of the match, the transaction is approved. In the case of a mismatch, the UIN holder is prompted to input the access code again, and the match is carried out a second time.
(48) If the match is successful, the transaction is approved. If the match is not successful on the second attempt, the transaction is rejected, and a transaction failure alert is generated to detect potential fraud.
(49) In case of transaction being rejected, depending on the rules and preferences set by the credit/debit card issuer and as agreed by the UIN holder, the merchant on whose premises the transaction is being performed is notified along-with the credit card issuer.
(50) In case the UIN holder and credit/debit card issuer have set the rules and preferences to additionally notify the law enforcement agency for a potential identity or credit/debit card theft, the appropriate law enforcement agency is notified.

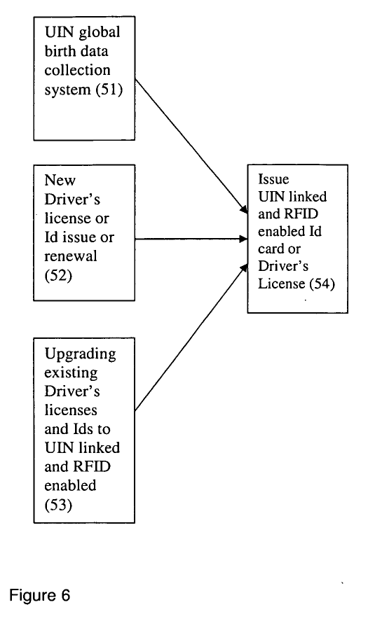

FIG. 6 explains the Type 1 UIN Card issue process (Id and Driver's License only application for those without the need of a credit/debit card, passport, visa, or loyalty program linking). UIN global birth data collection system (51), the request for issue of a new driver's license/state issued Id or its renewal (52), and the upgrading of existing driver's licenses and state issued Ids to become UIN linked and RFID enabled (53) become inputs to the process for issuing UIN linked and RFID enabled Id card or Driver's License (54).

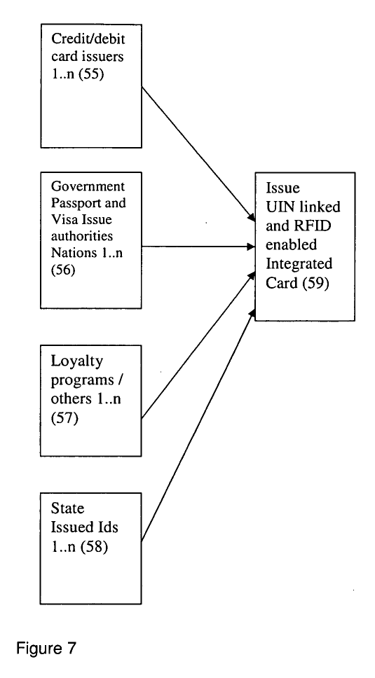

FIG. 7 explains the Type 2 Integrated UIN Card issue process (Driver's License and state issued Ids are rolled into the integrated credit/debit/ATM card, passport, visas, or loyalty program linking). One or more Credit/ debit/ ATM card issuers (55), Government Passport and Visa Issue authorities of different nations (56), Loyalty programs of several airlines, hotels, and other similar applications (57), and all state or federal issued Ids (58) become inputs to the process of issuing UIN linked and RFID enabled Integrated Card (59). This card becomes a single integrated card that is linked to all credit, debit, and ATM cards, visas, passports, loyalty programs, driver's license and state issued Ids.

All applicants shall be issued a UIN card by the appointed controlling agency. This card shall contain the UIN access code (encoded and in magnetic form that can only be read by swiping the card by an authorized agency) and vital life-saving information that can be used by hospitals and authorized medical practitioners under conditions of a medical emergency. For unique identification, picture and thumb print of the applicant are posted on the UIN Integrated Card. There is an RFID (Radio Frequency Identification) tag embedded into the UIN Integrated Card. The UIN Integrated Card can act as a credit card, debit card, driver's license, unique identification document, passport, visa, frequent flier card for all airlines, and all other applications that require the subscriber or holder to possess a unique identification document. It can be linked to all Ids issued by any government agencies and programs with whom the UIN central agency has coordinated agreements. Through bilateral agreements between the national federal and state governments, compliance to acts like Real Id act of the US government based on the recommendation of 9/11 Commission report can be achieved through UIN.

Alternately, if UIN Integrated Card is not required by the applicant, the state issued Ids like Driver's license or Identification Card can be linked to UIN and RFID enabled by embedding a tag.

The UIN global birth data collection system is not shown as an input to this system (59) under the assumption that in most cases, the UIN linked and RFID enabled Id has already been issued to a specific individual before they have the need for an integrated card. However, in some cases, if the UIN has not been previously assigned to the applicant of an integrated card (e.g. they may not have a state issued Id that is UIN linked), UIN has to be assigned at the time of issuing an integrated card to the applicant.

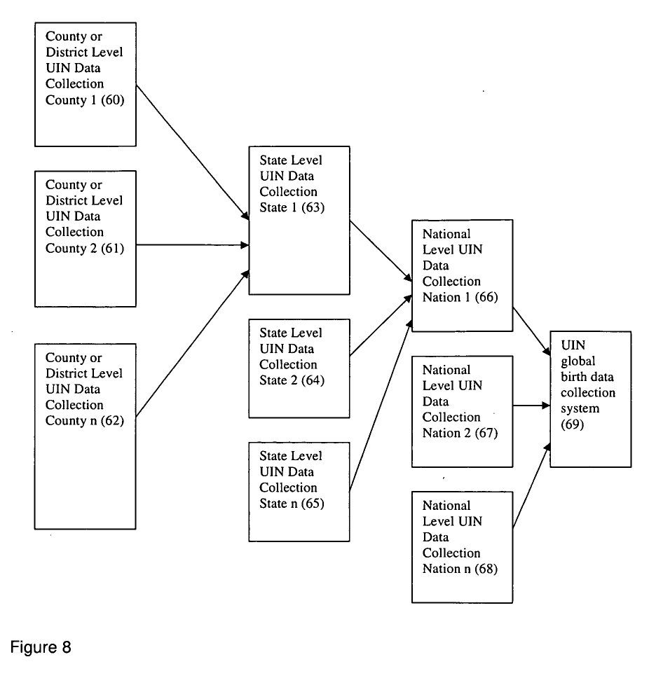

FIG. 8 explains the processes in UIN global birth data collection system. All the villages, towns, cities, and all other areas covered in any county or district of any state of any nation are the most granular level of this global data collection system. The various county or district level UIN Data collection through government established birth registration system (60, 61, 62) become the feeding end points to a state level UIN data collection system (63, 64, 65). The various state level UIN data collection systems become inputs to the national level UIN data collection system. The various national level UIN data collection systems (66, 67, 68) become inputs to the UIN global birth data collection system (69).

It is through bilateral state and national level agreements based on reciprocity that each state and nation can share data to the UIN system to enable the implementation of legal requirements like the ‘Real Id Act’ based on the recommendations of 9/11 commission report. This act requires every state to build the capability to search other state and nations' data for the issue of all existing Ids to an individual and get those cancelled, before issuing an Identification document; to avoid the abuse of state issued Ids.

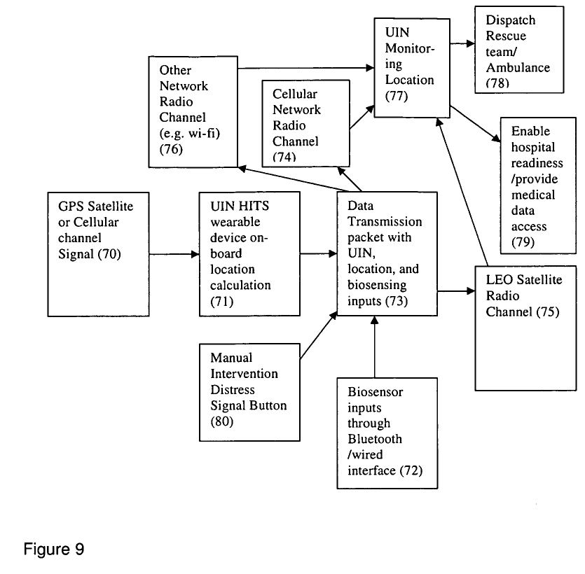

FIG. 9 explains the interactions between various components of a UIN based Human Identification and Tracking System (HITS). The GPS satellite or cellular channel signals (70) are fed to the UIN HITS human wearable device. The UIN HITS device (71) performs an on-board location calculation using the standard triangulation. The biosensing inputs from biosensors (in case the person carrying the HITS device is suffering from medical conditions requiring monitoring) are fed to the HITS device through Bluetooth or wired interface (72) and if any of these biosensing inputs cross a pre-set threshold limit, then these inputs trigger an alarm with the relevant bio-sensed code. This bio-sensed code, along with UIN and the location data (71) are assembled as an integrated data packet that is readied for transmission (73) and is simultaneously transmitted through multiple network channels like cellular network radio (74), signal to Low Earth Orbit (LEO) satellites (75), and other available media like wi-fi (76). The UIN monitoring site location receives these signals through any or all of these channels (77) and immediately initiates action to dispatch rescue teams or ambulance as applicable (78), and simultaneously enables hospital readiness in coordination with ambulance paramedics by identifying a suitable hospital in the vicinity of rescue location and authorizing access to patient's medical records for speedy diagnosis and treatment.

The HITS device also has a distress button (80) that can be pressed by the wearer. The pressing of this button triggers a distress signal that is transmitted in the same manner with UIN and location data as the bio-sensing generated alarm, and this signal is interpreted by the UIN monitoring location as an indication to rescue the UIN HITS device wearer. This distress button is of vital importance to prevent child abduction, as it would enable the child to press the button and raise an alert. Additionally, patients suffering from acute conditions such as Alzheimer's can also press the button for rescue even if the biosensors are unable to detect an abnormal medical condition. In both the cases, whether the distress signal is received through a manual intervention by pressing the button on HITS wearable device, or by the bio-sensing driven trigger alert, the UIN monitoring site immediately tries to establish a contact with the UIN holder through any available communication channel. Even if the contact can't be established, the UIN monitoring site proceeds with action to dispatch the rescue team or ambulance, as applicable, without any delay, and further enables hospital readiness while the patient is being rescued.

All UIN data is encrypted before transmission through the network, and is decrypted at the receiving end, and is transmitted over secured network channels and utilizes secured services for access through the messaging framework.

What is claimed is:

1. System, method, and apparatus for generating and applying global unique identification number as universal identification number which is issued only once to each and every human being that:
a) forever uniquely identifies each and every human being on the planet from birth to death and after; and
b) is used as a cross reference identifier in system and apparatus for identity verification, issue of passport, visa for travel to a foreign country, driving license, credit card, debit card, automated teller machine card issue and verification, human and patient tracking, monitoring, medical record access for diagnosis and treatment, and human rescue in conjunction with radio frequency identification, microwave, cellular communication, and satellite communication technologies, and a secured messaging framework and authorized database access; and
c) is used as a cross reference identifier in systems to collect, store, retrieve, parse, process, prepare, and present the biometrics data related to human eye iris pattern, deoxyribonucleic acid sample, and human identification database for uniquely identifying a human being for the purposes of law enforcement, will verification, genealogy, and applications requiring unique human identification; and
d) is used in a data access system by authorized law enforcement agencies provided with additional security access code to obtain identification information,
whereby only allowing authorized access to data; and
e) is used in a data access system by authorized hospitals or medical agencies provided with additional security access code to obtain medical records in a secured manner,
whereby providing immediate medical data enabling speedy diagnosis and treatment; and
f) is used in a system for credit, debit, and automated teller machine card transaction verification by matching an additional access code known to the holder of the said universal identification number received in an encrypted manner over a secured network and messaging framework,
whereby providing the authenticated and secured credit, debit, and automated teller machine card transactions, and alerting the card issuer and law enforcement agencies after the pre-determined number of attempts at input of correct authorization code fail, as agreed between the card holder and issuer; and
g) providing a human identification and tracking wearable device which will:
1 have means to receive global positioning satellite or cellular channel radio signals to perform an onboard location determination, and
2 have means to store and incorporate the said universal identification number data to the location data, and
3 have means to incorporate the abnormal medical condition data sent through wired or blue-tooth enabled biosensors indicating an alert, and
4 have means to incorporate the alert signal raised by said human identification and tracking device wearer by pressing of the distress signal button located on the device, and
5 have means to generate and incorporate the time stamp including date and time, and
6 have means to assemble the data packet incorporating the said location, universal identification number, abnormal medical condition, distress signal, and date time stamp data, and encrypt it for transmission over secured network channels, and
7 have means to transmit the data packet over the secured low earth orbit satellite channel, cellular network channel, wi-fi and additional available secured radio channels; and
h) providing a monitoring system to receive the said universal identification number data which will:
1 receive the distress signal data through secured alternate radio signal channels triggered when the wearer of a human identification and tracking device presses a distress signal button, decipher the data, determine the identity and location of the device wearer, attempt to establish a contact with the device wearer over any available channel, and dispatch the rescue team, and
2 receive the biosensor abnormal body condition signal data through secured alternate radio signal channels triggered when the biosensors generate an alert by detecting an abnormal body condition and this data is automatically sent by human identification and tracking device, decipher the data, determine the identity and location of the device wearer and the abnormal body condition, attempt to establish a contact with the device wearer over any available channel, and dispatch the ambulance, and
3 receive requests for providing information about the universal identification number holder, and appropriately processing these requests after duly authenticating and validating the identity and authorization access of the information seeker, and providing only the needed information as authorized by law to the seeker.

2. The method in accordance with claim 1, wherein said universal identification number as the unique human identifier is comprising the steps of:
a) issuing an association date in year as four numerals, month as two numerals, and date as two numerals in format yyyymmdd, followed by up to first three characters of the first name of a person and lastly followed by a computer generated four alphanumeric digits or characters; and
b) wherein the association date in the said universal identification number is comprising of a date that shall be the issue date for universal identification number, and if the universal identification number issue date, name characters, and the computer generated alphanumeric characters for the issue date are not available, then the association date is picked from those available from one of the previous dates in a time horizon window; and
c) wherein the first three characters of the first name of a person are the first three characters of a given name, and in cases of non availability of the first three characters of the first name, for reasons like the first name being shorter than three characters, the remaining characters of the first name shall be filled up by a computer-generated alphabetical sequence; and if the first name is not given owing to cultural or religious traditions or any other reasons, all characters of the first name shall be filled up by a computer generated alphabetical sequence; and
d) wherein the universal identification number comprising of a number representing a date and alphabetic characters representing name and alphanumeric characters representing a computer generated code, this arrangement is such that universal identification number comprises of, in the order for yyyy for year, mm for month, dd for date, nnn for name, cccc for computer generated code where yyyymmddnnncccc represents collectively the association date, followed by nnn for first name and cccc for computer generated code; and
e) a global universal identification number birth data collection system comprising of universal identification number data collection end points at all villages, towns, and cities feeding the county level universal identification number data collection system, and county level system feeding the state level universal identification number data collection system, and state level data collection system feeding the universal identification number national level data collection system, and national level systems feeding the global universal identification number data collection system, and becoming the input for universal identification number issuing system.

3. In accordance with claim 1, the data that is collected and makes the basis for issue of the universal identification number comprising of three sections, as public, health and confidential.

4. In accordance with claim 3, the first section of data collected is comprising of personal information under the public domain and captures the fields of first, middle and last name, each one of which can be up to forty characters in length; name is followed by sex indicated as male or female and the desired contact address with contact telephone number and e-mail address; the data in public domain shall be accessible at all times to those who have been issued the universal identification number followed by the public domain access code, and the public domain access code is known to the universal identification number holder who can pass it on to anyone with whom they desire to share this public domain information.

5. In accordance with claim 3, the second section of data collected is comprising of personal information under the health domain, and this data captures the date of birth in yyyymmdd format, blood type in 2 or 3 character width, immediate medical conditions that can require attention within 100 characters, details of up to 3 most severe known allergies each up to 40 characters, contact details of the current attending physician name, telephone, pager, address within 100 characters; emergency contact person relative or friend with contact details and a back-up emergency contact each within 100 characters in length; and the data under medical domain shall be accessible at all times online or by call only to authorized hospitals and registered medical practitioners who have the universal identification number followed by the medical domain access code; and this data is made available to authorized viewers along with the public domain access data.

6. In accordance with claim 3, the third section of data is comprising of personal information under the confidential domain and this data contains information about universal identification number holder that is of a confidential nature and captures the country of birth with state, county, address of birth place, time of birth, all detailed addresses where the universal identification number holder has lived over 5 years, details of educational qualifications with institutes attended, complete present address with telephone number, country of residence, country of citizenship and details of all identifications issued so far and all numbers issued like tax identification number, social security number, driver's licenses, state issued identifications, and details of all passports and visas ever carried or issued; and this data is periodically updated and the universal identification number holder owns the responsibility to submit data for verification and update to the universal identification number issuing authority; and the data related to educational qualifications including details of all schools attended, degrees or diplomas obtained, years of graduation, and subjects of major, professional affiliations, all places of work and positions held, name of supervisor and address of workplace with dates worked, professional societies, religious bodies or charitable and voluntary organization memberships and affiliations, positions held with dates since affiliated and addresses of the organizations, details of birth marks and identification marks, iris pattern of the eyes, color of eyes, hair and skin, finger prints, pictures, and in addition, deoxyribonucleic acid samples of the universal identification number holder obtained optionally and referenced with universal identification number and stored at a secured site in a protected environment.

7. In accordance with claim 6, the personal information under confidential domain is not disclosed to anyone who is not authorized to access this information, and the authorized law enforcement agencies would be able to access this information only by a combination of three keys and these three keys are public information access code given by the universal identification number holder, the security access key authorization code known only to the law enforcement agencies that is periodically changed to maintain confidentiality, and a third access code key that is specifically issued to the law enforcement officer requesting the information, and to get the third access code, the law enforcement personnel seeking information will need to identify themselves, and in order to access the information, they need to have their own universal identification number made available for identification and verification of their personal data to eliminate any attempts at fraud, and records of all confidential data sought would be maintained for a specific period.

8. In accordance with claim 1, the universal identification number holder shall be issued a universal identification number card that carries name of the universal identification number holder, picture of the universal identification number holder, and a thumb impression for unique identification; and blood type, known allergies, contact details of attending physician is printed on inside of the card and not visible from the outside; and the universal identification number card is a folded card with four visible surfaces that can hold data and information about the universal identification number holder and while two of the surfaces are covered in the inside fold, the two outer surfaces form the front and back of card,
whereby the card acting as an identification instrument and a life saver by providing vital medical information about the holder on the inside in case of an emergency.

9. In accordance with claim 1, the said universal identification number works as part of an integrated system to protect frauds, and said universal identification number supplementing with a tracking device operating through satellite and radio signals, the integrated system becoming human identification and tracking system.

10. In accordance with claim 1, the deoxyribonucleic acid sample obtained from the universal identification number applicant and stored securely by the universal identification number issuing and identity protection agency in a secure environment, and this deoxyribonucleic acid sample is released only in the case of the need to do so, upon appropriate request by a court of law under its authority and jurisdiction, in specific country that may normally be the residence nation of universal identification number holder, to settle legal issues and matters related to identity fraud or will enforcement, and the deoxyribonucleic acid sample is referenced to the universal identification number.

11. The method in accordance with claim 1d, the authorized law enforcement agency provides its additional secure access code to submit query and obtain the identity data using secured service through the universal identification number messaging framework.

12. The method in accordance with claim 1e, the authorized medical hospital or agency provides its additional secure access code to submit query and obtain the health record data using secured service through the universal identification number messaging framework.

13. The method in accordance with claim 1f, the credit, debit, and automated teller machine card transaction verification is achieved by matching an additional access code for security known to the holder of said universal identification number that is transmitted in an encrypted manner over a secured network and is matched with the universal identification number database using secured service through the universal identification number messaging framework, and fraud alert can be issued and card provider and law enforcement agency notified if the secure access code match fails the pre-specified number of attempts, as involved parties agreeing to the issuing of such alert and notification.

14. The method in accordance with claim 1b, the driver's license or state issued Id is linked to universal identification number and is secured by embedding a radio frequency identification tag, enabling fraud prevention, and providing access to law enforcement agencies to read the tag data and submit it securely through an access network to the universal identification number messaging framework for verification of identity.

15. The method in accordance with claim 1b, the apparatus for human or patient identification and tracking comprising of a wearable device receiving signals from global positioning system satellites, performing an on-board location calculation, and readying a secured data packet with universal identification number and alert generated by either manually pressing of the distress signal button or by the medical abnormal condition alert detected by the biosensing inputs for secure transmission over the multiple radio channels of low earth orbit satellites, cellular network, and wi-fi, and the universal identification number monitoring site receiving these signals securely by accessing the universal identification number messaging framework for verification of identity of the universal identification number holder, and dispatching rescue teams or ambulance with location information, identity of universal identification number holder, aiding in hospital readiness in consultation with ambulance paramedic staff, and enabling secure health data records access to the authorized hospital.

16. The method and apparatus in accordance with claim 1, an integrated card acting as a single identification document, passport, visas, driver's license, and credit, debit and automated teller machine cards, and loyalty programs per agreements between the universal identification number system issuing agency and the specific government agencies providing the identification documents, driver's license, passport, visa, the credit, debit and automated teller machine card providers, and loyalty program providers, linked to the said universal identification number and enabled with embedded radio frequency identification tag is issued to seeking holders of the said universal identification number.
